(19) United States
(12) Patent Application Publication
(10) Pub. No.: US 2010/0174484 A1
(43) Pub. Date: Jul. 8, 2010

(54) SYSTEM AND METHOD FOR OPTIMIZING HYBRID ENGINE OPERATION

(76) Inventors: Manthram Sivasubramaniam, Bangalore (IN); Paul K. Houpt, Schenectady, NY (US); Ajit Wasant Kane, Erie, PA (US); Ajith Kumar, Erie, PA (US); Lembit Salasoo, Schenectady, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/348,393

(22) Filed: Jan. 5, 2009

(51) Int. Cl. G01C 21/00; B60W 20/00

(52) U.S. Cl. 701/213; 701/200; 903/904

(57) ABSTRACT

A system for optimizing a trip for a hybrid vehicle, comprising a computer programmed to determine a route for the hybrid vehicle to travel, obtain altitude and terrain information of the route, and generate a trip plan based on at least the route and altitude to minimize total energy expended along the route by encouraging regenerative braking during portions of the route, regardless of needs to slow the hybrid vehicle.

### BACKGROUND

1. Technical Field

The invention includes embodiments that relate to a hybrid locomotive navigation system and to a method of using the system.

2. Discussion of Art

In operating a vehicle such as a locomotive, some of the factors that an operator may take into account include environmental conditions, grade or slope, track or path curvature, speed limits, vehicle size, weight of the cargo, and distribution of that weight. Operation of the vehicle may be determined in part by an automatic locomotive control system configured to automatically accelerate and decelerate the vehicle.

The automatic locomotive control system having, for example, a navigation system and a pacing system may benefit from a database that depicts track or path features and locations. Such features may be input to an optimizing program that includes locator elements to determine location of the locomotive, track characterization elements, sensors for measuring operating conditions, and the like. The optimizing program may include locomotive power description, performance of locomotive traction transmission, consumption of engine fuel as a function of output power, and other system performance characteristics that may enable system performance to be modeled. The optimizing program may be an algorithm embodied within a processor to optimize performance about an objective function that may include, as examples, minimizing travel time, minimizing notch jockeying, and minimizing emissions to comply with EPA standards, as examples.

In conventional diesel locomotives, such a control system typically optimizes fuel consumption by minimizing avoidable braking in scenarios that may include running up on speed limits, braking before inclines, braking to control overspeeds, and the like. Such systems express braking as an undesirable and wasteful operating characteristic because braking is generally assumed to unnecessarily consume fuel when acceleration is needed after the braking operation is complete.

Braking energy may be recaptured, to an extent, by including a hybrid engine in the locomotive to recapture braking energy and to improve efficiency. However, because optimizing programs, if not explicitly formulated for a hybrid locomotive operation, may express braking as an undesirable characteristic, the system may not take full advantage of energy efficiencies and recapture capabilities of hybrid engines, and thus may not operate at peak efficiency.

Therefore, it may be desirable to have a system and method that improves energy efficiency in an optimizing program.

### BRIEF DESCRIPTION

According to an aspect of the invention, a system for optimizing a trip for a hybrid vehicle includes a computer programmed to determine a route for the hybrid vehicle to travel, obtain altitude and terrain information of the route, and generate a trip plan based on at least the route and altitude to minimize total energy expended along the route by encouraging regenerative braking during portions of the route, regardless of needs to slow the hybrid vehicle.

In accordance with another aspect of the invention, a method includes obtaining grade information along a route for a hybrid vehicle to travel, and generating an optimized trip plan to minimize total fuel consumption of the hybrid vehicle by promoting regenerative braking to occur during periods, for the purpose of generating energy, even when the vehicle need not be slowed.

In accordance with yet another aspect of the invention, a vehicle includes a hybrid power source to provide power to drive the vehicle via a drivetrain, the hybrid power source comprising an internal combustion (IC) engine and an electric motor, wherein the IC engine is coupled to the drivetrain, and a bank of batteries coupled to the electric motor. The vehicle includes a switching device arranged to selectively couple the electric motor to the drivetrain. The vehicle includes a computer configured to generate a trip plan for a route from a first point to a second point, obtain grade information for the trip plan, optimize the trip plan to minimize fuel consumption, by inducing regenerative braking to occur irrespective of momentum requirements. The regenerative braking occurs by selectively coupling the drivetrain to the electric motor when the vehicle is braking.

Various other features will be apparent from the following detailed description and the drawings.

### BRIEF DESCRIPTION OF THE DRAWINGS

The drawings illustrate an embodiment of the invention. For ease of illustration, a locomotive and track system has been identified, but other vehicles and vehicle routes are included except were language or context indicates otherwise.

FIG. 1 is a block diagram illustrating a hybrid vehicle incorporating embodiments of the invention.

FIG. 2 is a flow chart useful in incorporating the invention in the hybrid vehicle of FIG. 1.

FIG. 3 is a flow chart of a technique according to the invention.

FIG. 4 is an illustration of a flow chart according to the invention.

### DETAILED DESCRIPTION

The invention includes embodiments that relate to route navigation systems. The invention includes embodiments that relate to methods for generating optimized trips for a hybrid vehicle.

The invention is described with respect to a hybrid engine of a locomotive. However, one skilled in the art will recognize that the embodiments and methods illustrated herein may be broadly applied to hybrid vehicles in general.

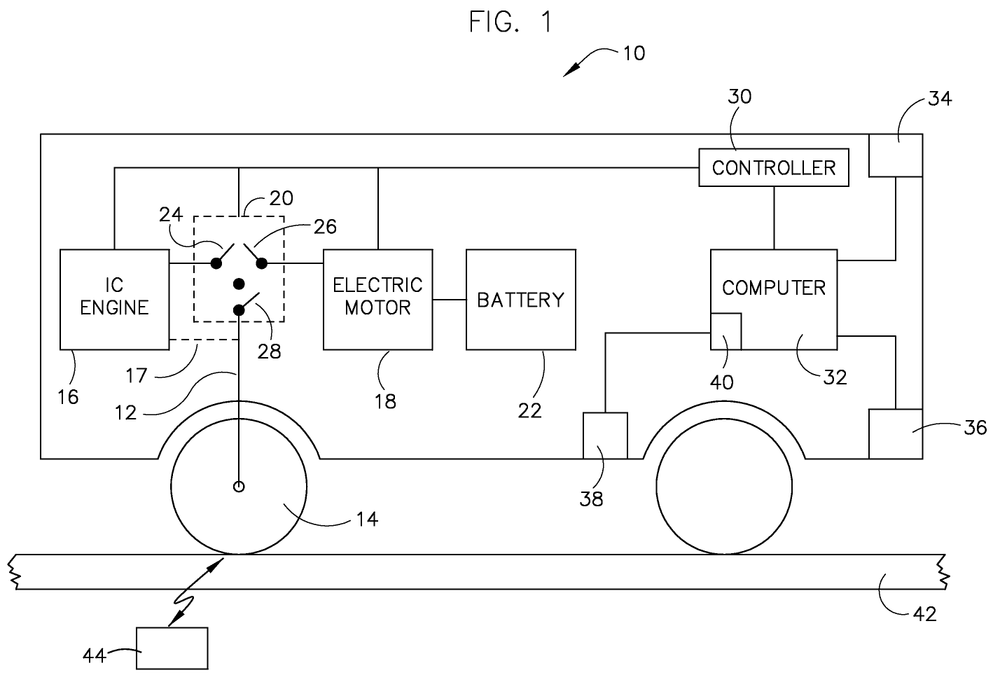

FIG. 1 illustrates a hybrid vehicle 10 incorporating embodiments of the invention. Hybrid vehicle 10 includes a drivetrain 12 configured to impart power to a wheel 14 of hybrid vehicle 10. Hybrid vehicle 10 includes an engine 16, such as an internal combustion (IC), and an electric motor 18 coupled to drivetrain 12 via a bank of switching elements 20. Electric motor 18 is coupled to a battery or bank of batteries 22. The bank of switching elements 20 are illustrated as a set of switches 24, 26, 28, that selectively couple the engine 16 to the electric motor 18, and selectively couple one or both of the engine 16 and the electric motor 18 to drivetrain 12. In embodiments, switches 24, 26, 28, are a mechanical clutch, a gear train, and the like, that are configured to impart mechanical power to and from drivetrain 12. Switches 24, 26, 28, are selectively controlled by a controller 30 that is coupled to a computer 32.

In one embodiment of the invention, engine 16 is coupled directly to wheel 14, as illustrated as direct drive 17 (shown in phantom) via drivetrain 12. In such an embodiment, switch 24 is foregone and engine 16 coupling to electric motor 18 is controlled via switch 26. Likewise, in such an embodiment, coupling between electric motor 18 and wheel 14 is via switches 26 and 28. In such an embodiment, engine 16 is coupled directly to wheel 14, engine 16 may be selectively coupled to electric motor via switch 26, and electric motor 18 may be selectively coupled to wheel 14 via switches 26 and 28. Thus, although operation below is described with respect to the use of switches 24, 26, and 28, one skilled in the art will recognize that the operation described may be implemented in an embodiment where engine 16 is directly coupled to wheel 14.

In operation, switches 24, 26, 28, of hybrid vehicle 10 may be selectively coupled to drivetrain 12 from engine 16, from electric motor 18, or both. Thus, by closing switches 24 and 28 and opening switch 26, as an example, engine 16 is coupled to drivetrain 12 and may directly impart power thereto to drive wheel 14. Alternatively, by closing switches 26 and 28 and opening switch 24, electric motor 18 is coupled to drivetrain 12 and may directly impart power thereto by drawing energy from bank of batteries 22.

Further, by closing switches 24 and 26 and opening switch 28, engine 16 may be coupled to electric motor 18, providing power thereto to charge the bank of batteries 22 when no power is needed in the drivetrain 12. Such may occur during periods when hybrid vehicle 10 is stationary, or descending in altitude, as examples. If power is needed in the drivetrain 12, switch 28 may instead be closed as well to simultaneously provide power from engine 16 to both electric motor 18 and drivetrain 12. In such a configuration, engine 16 may be operated to provide power to both drivetrain 12 and to charge the bank of batteries 22.

Additionally, switches 24, 26, and 28 of hybrid vehicle 10 may be selectively coupled to impart regenerative braking power to bank of batteries 22. Thus, during braking operations of hybrid vehicle 10, by closing switches 26 and 28 and opening switch 24, power generated in wheel 14 may be directed to provide power to drivetrain 12, which in turn provides power to electric motor 18 in order to convert and store the energy therefrom in the bank of batteries 22. As such, energy used to stop hybrid vehicle 10 may be recaptured and stored in the bank of batteries 22, which may be later used to provide power to the hybrid vehicle 10 or accessories thereof.

FIG. 1 further illustrates computer 32 configured to receive information from a locator element 34, a track characterizing element 36, and sensors 38. An algorithm 40 operates within the computer 32 and is configured to generate a trip plan according to embodiments of the invention. The hybrid vehicle 10 is positioned on a track 42, and information may be transmitted to the hybrid vehicle 10 via wireless communication from a central or a wayside location wayside location 44. The algorithm 40 is used to compute an optimized trip plan based on conditions and parameters involving the hybrid vehicle 10, track 42, such as number of locomotives, total load, and the like. The algorithm 40 also takes into account objectives of the mission that may include a travel time, maximum power setting, maximum speed limits, exhaust emission, an amount of throttle jockeying of the hybrid vehicle, or the like.

In an exemplary embodiment, the trip plan is established based on models for train behavior as the hybrid vehicle 10 moves along the track 42, as a solution of non-linear differential equations derived from physics with simplifying assumptions that are provided in the algorithm 40. The algorithm 40 has access to the information from the locator element 34, track characterizing element 36, and/or sensors 38 to create the trip plan minimizing fuel consumption while maintaining emissions within acceptable standards, establishing a desired trip time, and/or ensuring proper crew operating time. Controller 30 controls switches 24, 26, 28, according to algorithm 40, as it follows the trip plan, and engages and disengages the engine 16 from the drivetrain 12 and the electric motor 18, and engages and disengages the electric motor 18 from the drivetrain 12. In one embodiment the controller 30 makes train operating decisions autonomously, and in another embodiment the operator may be involved with directing the train to follow the trip plan.

According to one embodiment of the invention, the trip plan may be modified in real time while being executed. Thus, an initial plan may be determined when a long distance is involved, but owing to the complexity of the plan optimization algorithm 40 and changing conditions, the plan may be modified accordingly. The algorithm 40 may also be used to segment the mission wherein the mission may be divided by waypoints. Though only a single algorithm 40 is discussed, those skilled in the art will readily recognize that more than one algorithm 40 may be used in series or in parallel.

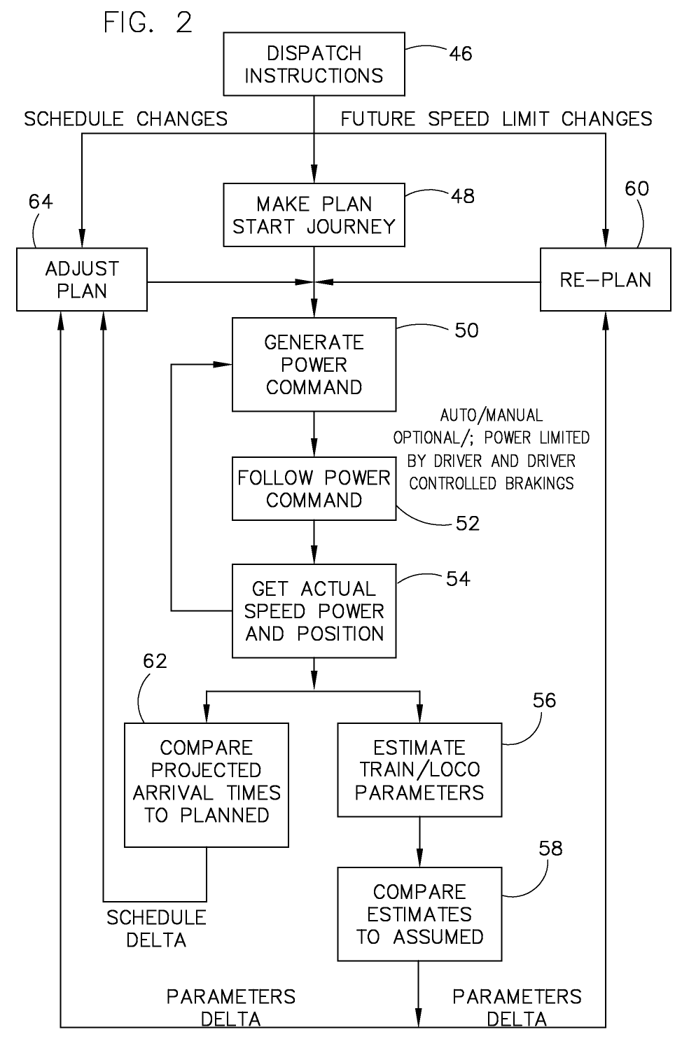

FIG. 2 depicts an exemplary illustration of a flow chart of the invention. As illustrated, instructions are input specific to planning a trip either on board or from a remote location, such as a dispatch center with instructions 46. Such input information includes, but is not limited to, train position, consist description (i.e. one or more locomotives in succession), locomotive power description, regenerative braking characteristics, performance of locomotive traction transmission, consumption of engine fuel as a function of output power, cooling characteristics, the intended trip route (effective track grade and curvature as function of milepost or an “effective grade” component to reflect curvature following standard railroad practices), the train represented by car makeup and loading together with effective drag coefficients, trip desired parameters including, but not limited to, start time and location, end location, desired travel time, crew (user and/or operator) identification, crew shift expiration time, and route.

This data may be provided to the hybrid vehicle 10 in a number of ways, such as, but not limited to, an operator manually entering this data into the hybrid vehicle 10 via an onboard display, inserting a memory device such as a hard card and/or USB drive containing the data into a receptacle aboard the locomotive, or transmitting the information via wireless communication from central or a wayside location 44 (illustrated in FIG. 1), such as a track signaling device and/or a wayside device, to the hybrid vehicle 10. Hybrid vehicle 10 load characteristics (e.g., drag) may change over the route (e.g., with altitude, ambient temperature and condition of the rails and rail-cars), and the plan may be updated to reflect such changes as needed by, such as, real-time autonomous collection of locomotive/train conditions. This includes for example, changes in hybrid vehicle 10 characteristics detected by monitoring equipment on or off board the hybrid vehicle 10.

Based on the specification data, an optimal plan which minimizes fuel use subject to speed limit constraints, emissions limits, and the like, along the route, with desired start and end times, is computed to produce a trip profile at 48. The trip profile includes, according to a preferred embodiment of the invention and as will be discussed later, periods where regenerative braking is encouraged to happen to take advantage of the regenerative capabilities of hybrid vehicle 10. The profile contains the optimal speed and power (notch) settings the train is to follow, expressed as a function of distance and/or time, and such train operating limits, including but not limited to, maximum notch power and brake settings, speed limits as a function of location, and the expected fuel used and emissions generated. In another embodiment, instead of operating at the traditional discrete notch power settings, the present invention is able to select a continuous power setting determined as optimal for the profile selected. Thus, for example, if an optimal profile specifies a notch setting of 6.8, instead of operating at notch setting 7, the hybrid vehicle 10 can operate at 6.8 to further improve efficiency thereof.

The procedure used to compute the optimal profile can be any number of methods for computing a power sequence that drives the hybrid vehicle 10 to minimize fuel subject to locomotive operating conditions, emissions, schedule constraints, or the like. In some cases the optimal profile may be close enough to one previously determined, owing to the similarity of the train configuration, route and environmental conditions. In these cases it may be sufficient to look up the driving trajectory within a database of previously executed trip plans and follow it. When no previously computed plan is available or suitable, methods to compute a new one include, but are not limited to, direct calculation of the optimal profile using differential equation models which approximate the train physics of motion. The setup involves selection of a quantitative objective function, or a weighted sum (integral) of model variables that correspond to travel time, rate of fuel consumption, maximum power settings, speed limits, emissions generation, plus a term to penalize excessive throttle variation or jockeying, as examples.

Depending on planning objectives at any time, the problem may be setup flexibly to minimize fuel subject to constraints on emissions and speed limits, or to minimize emissions, subject to constraints on fuel use and arrival time, as examples. It is also possible to setup, for example, a goal to minimize the total travel time without constraints on total emissions or fuel use where such relaxation of constraints would be permitted or required for the mission.

Using this model, an optimal control formulation is set up to minimize the quantitative objective function subject to constraints including but not limited to, speed limits and minimum and maximum power (throttle) settings. Depending on planning objectives at any time, the problem may be setup flexibly to minimize fuel subject to constraints on emissions and speed limits, or to minimize emissions, subject to constraints on fuel use and arrival time.

Reference to emissions in the context of the present invention is directed toward cumulative emissions produced in the form of oxides of nitrogen (NOx), unburned hydrocarbons, particulates, and/or the like. If a key objective during a trip mission is to reduce total emissions, algorithm 40 may be generated or amended to consider this trip objective in conjunction with improved overall fuel efficiency. A key flexibility in the optimization setup is that any or all of the trip objectives can vary by geographic region or mission. For example, for a high priority train, minimum time may be the only objective on one route because it is high priority traffic. In another example emission output could vary from state to state along the planned train route.

Referring still to FIG. 2, once the trip profile is generated at 48, power commands are generated at 50 to put the plan in motion. Depending on the operational set-up of the present invention, one command is for the locomotive to follow the optimized power command 52 so as to achieve an optimal speed. The invention obtains actual speed and power information from the locomotive consist of the hybrid vehicle 10 at step 54. Owing to the inevitable approximations in the models used for the optimization, a closed-loop calculation of corrections to optimized power is obtained to track the desired optimal speed. Such corrections of train operating limits can be made automatically or by the operator, who traditionally has ultimate control of the train.

In some cases, the model used in the optimization may differ significantly from the actual train. This can occur for many reasons, including but not limited to, extra cargo pickups or setouts, locomotives that fail in route, and errors in the initial database or data entry by the operator. For these reasons, a monitoring system is in place that uses real-time train data to estimate locomotive and/or train parameters in real time at step 56. The estimated parameters are then compared at step 58 to the assumed parameters used when the trip was initially created at step 48. Based on differences in the assumed and estimated values, the trip may be re-planned at step 60. Other reasons a trip may be re-planned include directives from a remote location, such as dispatch and/or the operator requesting a change in objectives to be consistent with more global movement planning objectives. More global movement planning objectives may include, but are not limited to, other train schedules, allowing exhaust to dissipate from a tunnel, maintenance operations, etc. Another reason may be due to an onboard failure of a component.

In operation, the hybrid vehicle 10 will continuously monitor system efficiency and continuously update the trip plan based on the actual efficiency measured, whenever such an update would improve trip performance. Re-planning computations may be carried out entirely within the locomotive(s) or fully or partially moved to a remote location, such as dispatch or wayside processing facilities where wireless technology is used to communicate the plans to the hybrid vehicle 10. The invention may also generate efficiency trends that can be used to develop locomotive fleet data regarding efficiency transfer functions. The fleet-wide data may be used when determining the initial trip plan, and may be used for network-wide optimization tradeoff when considering locations of a plurality of trains.

Many events in daily operations can lead to a need to generate or modify a currently executing plan, where it is desired to keep the same trip objectives, and for when a train is not on schedule for planned meet or pass with another train and it needs to make up time. Using the actual speed, power and location of the locomotive, a comparison is made between a planned arrival time and the currently estimated (predicted) arrival time at step 62, based on the remaining portion of the trip plan. Based on a difference in the times, as well as the difference in parameters (detected or changed by dispatch or the operator), the plan is adjusted at step 64. This adjustment may be made automatically or manually following a railroad company's desire for how such departures from the plan should be handled. Whenever a plan is updated, such as but not limited to arrival time, additional changes may be factored in concurrently, e.g. new future speed limit changes, which could affect the feasibility of ever recovering the original plan. In such instances if the original trip plan cannot be maintained, or in other words the train is unable to meet the original trip plan objectives, as discussed herein other trip plan(s) may be presented to the operator and/or remote facility, or dispatch.

Re-planning at step 60 may also be made when it is desired to change the original objectives. Such re-planning can be done at either fixed preplanned times, manually at the discretion of the operator or dispatcher, or autonomously when predefined limits, such a train operating limits, are exceeded. For example, if the current plan execution is running late by more than a specified threshold, such as thirty minutes as an example, the present invention can re-plan the trip at step 60 to accommodate the delay which is again based on minimizing total fuel consumption for the remaining portion of the trip, based on the new set of parameters. Other triggers for re-plan can also be envisioned based on the health of the power consist, including but not limited time of arrival, loss of horsepower due to equipment failure and/or equipment temporary malfunction (such as operating too hot or too cold), and/or detection of gross setup errors, such in the assumed train load. That is, if the change reflects impairment in the locomotive performance for the current trip, these may be factored into the models and/or equations used in the optimization.

Changes in plan objectives can also arise from a need to coordinate events where the plan for one train compromises the ability of another train to meet objectives and arbitration at a different level, e.g. the dispatch office is required. For example, the coordination of meets and passes may be further optimized through train-to-train communications. Thus, as an example, if a train knows that it is behind in reaching a location for a meet and/or pass, communications from the other train can notify the late train (and/or dispatch). The operator can then enter information pertaining to being late into the present invention wherein the present invention will recalculate the train's trip plan, again optimizing and minimizing fuel consumption while taking advantage of planned regenerative braking. The present invention can also be used at a high level, or network-level, to allow a dispatch to determine which train should slow down or speed up should a scheduled meet and/or pass time constraint may not be met. As discussed herein, this is accomplished by the trains transmitting data to the dispatch to prioritize how each train should change its planning objective. A choice could depend either from schedule or fuel saving benefits, depending on the situation.

For any of the manually or automatically initiated re-plans, the present invention may present more than one trip plan to the operator. In an exemplary embodiment the present invention will present different profiles to the operator, allowing the operator to select the arrival time and understand the corresponding fuel and/or emission impact. Such information can also be provided to the dispatch for similar consideration, either as a simple list of alternatives or as a plurality of tradeoff curves.

The present invention has the ability of learning and adapting to key changes in the train and power consist which can be incorporated either in the current plan and/or for future plans. For example, one of the triggers discussed above is loss of horsepower. When building up horsepower over time, either after a loss of horsepower or when beginning a trip, transition logic is utilized to determine when desired horsepower is achieved.

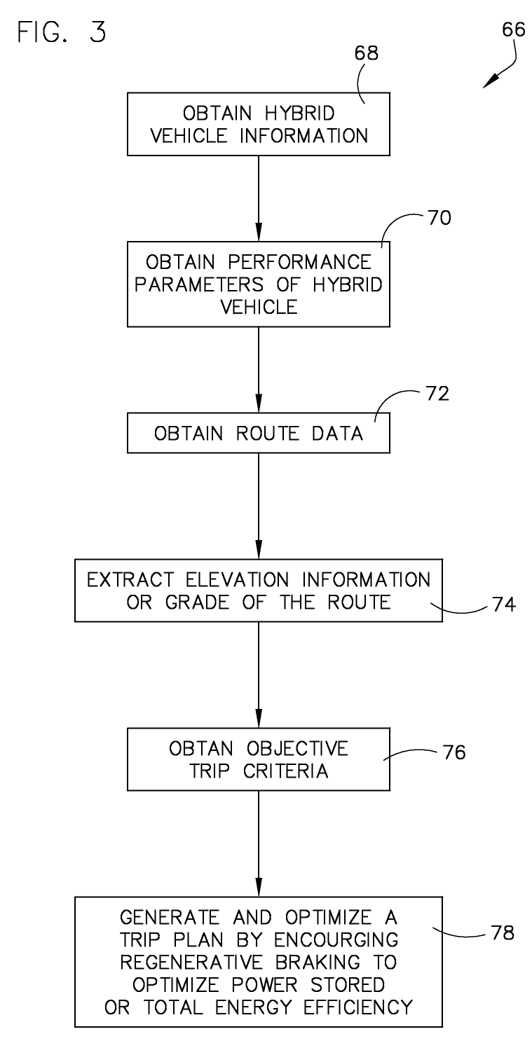

Regardless of the combination of objective functions established and the combination of performance parameters of the hybrid vehicle used to optimize a trip plan, total fuel efficiency may be improved by encouraging regenerative braking to occur during portions of the route. Thus, when planning a trip profile at step 48 of FIG. 2, when re-planning at step 60, or when adjusting the plan at step 64, an optimized trip profile may be obtained as outlined in FIG. 3.

Referring now to FIG. 3, step 48 of FIG. 2 is illustrated as technique 66, according to one preferred embodiment of the invention. Technique 66 begins by obtaining hybrid vehicle information at step 68, which may include but is not limited to number of locomotives, total load, and the like. Performance parameters are obtained at step 70 that may include, but are not limited to, locomotive power data, regenerative braking characteristics, performance of locomotive traction transmission, consumption of engine fuel as a function of output power, and cooling characteristics of the hybrid vehicle, as examples. Route data is obtained at step 72, which may include a single leg from a first point to a second point, or multiple legs between points. The route data obtained at step 72 may include altitude and terrain, or grade information that is extracted at step 74 and used to optimize the trip plan according to the invention.

Technique 66 includes step 76 wherein objective trip criteria are obtained which constrain the optimization. The objective trip criteria may include, but are not limited to, a travel time, a maximum power setting, a speed limit, an exhaust emission, and a throttle jockeying of the hybrid vehicle. At step 78, a trip plan is generated and optimized by encouraging or promoting regenerative braking to occur to optimize power stored in the batteries. Such optimization may occur, according to the invention, irrespective of momentum or braking requirements of the hybrid vehicle 10 during periods of the trip. In other words, the optimized trip plan may call for accelerating on flat portions of a route via the IC engine or may call for accelerating going up a hill via the IC engine, such that energy may be regeneratively recovered during, for instance, downslopes or downgrades along the route. The optimized trip plan may also include drawing down the batteries during portions of the trip such that adequate storage capacity is available in the batteries in advance of a regenerative braking period. Thus, a total trip may be optimized about fuel consumption, and overall fuel efficiency may be improved by generating a trip plan that encourages regenerative braking to occur during portions of the trip that otherwise would not have regenerative braking, all while satisfying the overriding objective trip criteria.

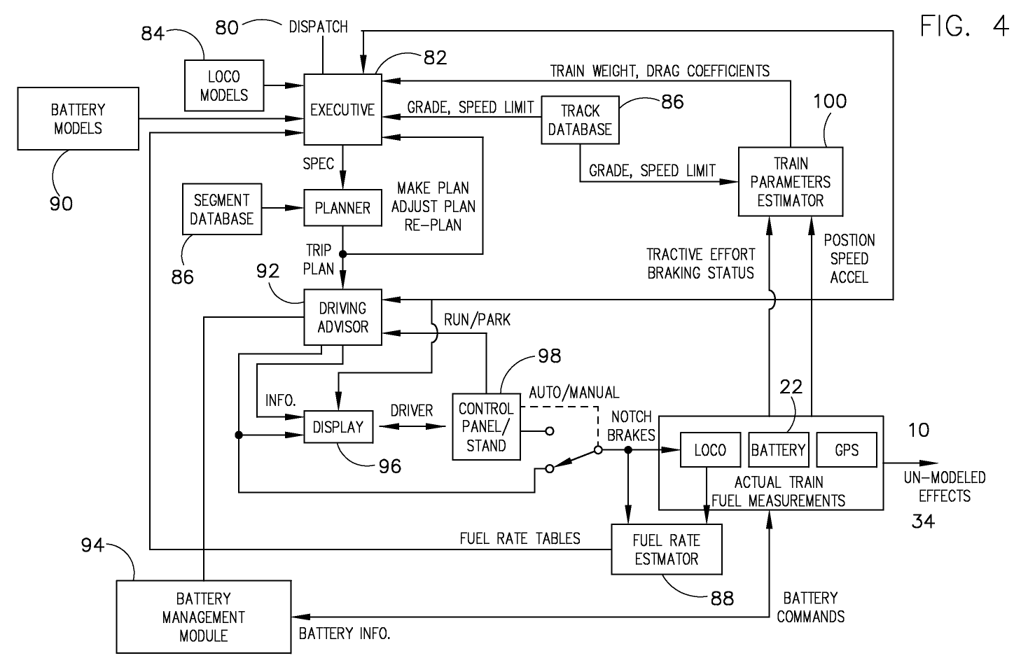

FIG. 4 depicts an exemplary flow chart of the present invention. A remote facility, such as a dispatch 80 can provide information according to the present invention. As illustrated, such information is provided to an executive control element 82. Also supplied to the executive control element 82 is a locomotive modeling information database 84, information from a track database 86 such as, but not limited to, track grade information and speed limit information, estimated train parameters such as, but not limited to, train weight and drag coefficients, fuel rate tables from a fuel rate estimator 88, and battery models 90 that describe battery efficiency and recovery of energy during, for instance, regenerative braking. The executive control element 82 supplies information to the planner, as in step 48 in FIG. 2, and a trip plan is calculated. Once a trip plan has been calculated, the plan is supplied to a driving advisor, driver or controller element 92. The controller element 92 is coupled to a battery management module 94 that controls charging and discharging of the bank of batteries 22 according to the trip plan as executed by the controller element 92. The trip plan is also supplied to the executive control element 82 so that it can compare the trip when other new data is provided.

The controller element 92 can automatically set a notch power, either a pre-established notch setting or an optimum continuous notch power. In addition to supplying a speed command to the hybrid vehicle 10, a display 96 is provided so that the operator can view what the planner has recommended. The operator also has access to a control panel 98. Through the control panel 98, the operator can decide whether to apply the notch power recommended. Toward this end, the operator may limit a targeted or recommended power. That is, at any time the operator always has final authority over what power setting the locomotive consist will operate at. This includes deciding whether to apply braking if the trip plan recommends slowing the hybrid vehicle 10. For example, if operating in dark territory, or where information from wayside equipment cannot electronically transmit information to a train and instead the operator views visual signals from the wayside equipment, the operator inputs commands based on information contained in track database and visual signals from the wayside equipment. Based on how the hybrid vehicle 10 is functioning, information regarding fuel measurement is supplied to the fuel rate estimator 88. Since direct measurement of fuel flows is not typically available in a locomotive consist, information on fuel consumed within a trip, and projections into the future following optimal plans, is carried out using calibrated physics models such as those used in developing the optimal plans. For example, such predictions may include but are not limited to the use of measured gross horse-power and known fuel characteristics to derive the cumulative fuel used.

The hybrid vehicle 10 also has a locator element 34, such as a GPS sensor, and a bank of batteries 22 as illustrated in FIG. 1. Information is supplied to a train parameters estimator 100. Such information may include, but is not limited to, GPS sensor data, tractive/braking effort data, braking status data, speed and any changes in speed data. With information regarding grade and speed limit information, train weight and drag coefficients information is supplied to the executive control element 82.

The invention may also allow for the use of continuously variable power throughout the optimization planning and closed loop control implementation. In a conventional locomotive, power is typically quantized to eight discrete levels. Modern locomotives can realize continuous variation in horsepower which may be incorporated into the previously described optimization methods. With continuous power, the hybrid vehicle 10 can further optimize operating conditions, e.g., by minimizing auxiliary loads and power transmission losses, and fine tuning engine horsepower regions of optimum efficiency, or to points of increased emissions margins. Examples include, but are not limited to, minimizing cooling system losses, adjusting alternator voltages, adjusting engine speeds, and reducing number of powered axles. Further, the hybrid vehicle 10 may use the track database 86 and the forecasted performance requirements to minimize auxiliary loads and power transmission losses to provide optimum efficiency for the target fuel consumption/emissions. Examples include, but are not limited to, reducing a number of powered axles on flat terrain and pre-cooling the locomotive engine prior to entering a tunnel.

The invention may also use the track database 86 and the forecasted performance to adjust the locomotive performance, such as to ensure that the train has sufficient speed as it approaches a hill and/or tunnel. For example, this could be expressed as a speed constraint at a particular location that becomes part of the optimal plan. Additionally, the present invention may incorporate train-handling rules, such as, but not limited to, tractive effort ramp rates, maximum braking effort ramp rates. These may incorporated directly into the formulation for optimum trip profile or alternatively incorporated into the closed loop regulator used to control power application to achieve the target speed.

In a preferred embodiment the present invention is only installed on a lead locomotive of the train consist. However, interaction with multiple trains is not precluded and two or more independently optimized trains may be controlled according to the invention.

Trains with distributed power systems can be operated in different modes. One mode is where all locomotives in the train operate at the same notch command. Thus, if the lead locomotive is commanding motoring-N8, all units in the train will be commanded to generate motoring-N8 power. Another mode of operation is “independent” control. In this mode, locomotives or sets of locomotives distributed throughout the train can be operated at different motoring or braking powers. For example, as a train crests a mountaintop, the lead locomotives (on the down slope of mountain) may be placed in braking, while the locomotives in the middle or at the end of the train (on the up slope of mountain) may be in motoring. This is done to minimize tensile forces on the mechanical couplers that connect the railcars and locomotives. Traditionally, operating the distributed power system in “independent” mode required the operator to manually command each remote locomotive or set of locomotives via a display in the lead locomotive. Using the physics based planning model, train set-up information, on-board track database, on-board operating rules, location determination system, real-time closed loop power/brake control, and sensor feedback, the system shall automatically operate the distributed power system in “independent” mode.

When operating in distributed power, the operator in a lead locomotive can control operating functions of remote locomotives in the remote consists via a control system, such as a distributed power control element. Thus when operating in distributed power, the operator can command each locomotive consist to operate at a different notch power level (or one consist could be in motoring and other could be in braking) wherein each individual locomotive in the locomotive consist operates at the same notch power. In an exemplary embodiment, with the present invention installed on the train, preferably in communication with the distributed power control element, when a notch power level for a remote locomotive consist is desired as recommended by the optimized trip plan, the present invention will communicate this power setting to the remote locomotive consists for implementation. The same is true regarding braking.

The present invention may be used with consists in which the locomotives are not contiguous, e.g., with 1 or more locomotives up front, others in the middle and at the rear for train. Such configurations are called distributed power wherein the standard connection between the locomotives is replaced by radio link or auxiliary cable to link the locomotives externally. When operating in distributed power, the operator in a lead locomotive can control operating functions of remote locomotives in the consist via a control system, such as a distributed power control element. In particular, when operating in distributed power, the operator can command each locomotive consist to operate at a different notch power level (or one consist could be in motoring and other could be in braking) wherein each individual in the locomotive consist operates at the same notch power.

In an exemplary embodiment, with the invention installed on the train, preferably in communication with the distributed power control element, when a notch power level for a remote locomotive consist is desired as recommended by the optimized trip plan, the present invention will communicate this power setting to the remote locomotive consists for implementation. The same is true regarding braking. When operating with distributed power, the optimization problem previously described can be enhanced to allow additional degrees of freedom, in that each of the remote units can be independently controlled from the lead unit. The value of this is that additional objectives or constraints relating to in-train forces may be incorporated into the performance function, assuming the model to reflect the in-train forces is also included. Thus the invention may include the use of multiple throttle controls to better manage in-train forces as well as fuel consumption and emissions. In such an embodiment, regenerative braking enhances overall fuel efficiency by, or instance, regeneratively braking one locomotive while simultaneously applying power to another.

In a train utilizing a consist manager, the lead locomotive in a locomotive consist may operate at a different notch power setting than other locomotives in that consist. The other locomotives in the consist operate at the same notch power setting. The invention may be utilized in conjunction with the consist manager to command notch power settings and regenerative braking commands for the locomotives in the consist. Thus based on the invention and as an example, because the consist manager divides a locomotive consist into two groups, lead locomotive and trail units, the lead locomotive will be commanded to operate at a certain notch power and the trail locomotives are commanded to operate at another certain notch power. In an exemplary embodiment the distributed power control element may be the system and/or apparatus where this operation is housed.

Likewise, when a consist optimizer is used with a locomotive consist, the present invention can be used in conjunction with the consist optimizer to determine notch power for each locomotive in the locomotive consist, thus providing the overall required net power. For example, suppose that a trip plan recommends a notch power setting of 4 for the locomotive consist. Based on the location of the train, the consist optimizer will take this information and then determine the notch power setting for each locomotive in the consist. In this implementation, the efficiency of setting notch power settings over intra-train communication channels is improved. Furthermore, as discussed above, implementation of this configuration may be performed utilizing the distributed control system. Additionally, in an embodiment of the invention, the trip optimizer algorithm described herein may, for periods of the trip, force the engine to operate in less efficient modes (such as a peak power of the internal combustion engine in conjunction with drawing from the batteries). Such operation may be to make up for lost time or to provide additional acceleration capability than can be provided by the internal combustion engines alone. However, in such embodiments, although short periods of decreased efficiency may occur, overall efficiency is improved, as the trip optimizer takes full account of combined efficiencies during the planned trip.

Furthermore, as discussed previously, the present invention may be used for continuous corrections and re-planning with respect to when the train consist uses braking based on upcoming items of interest, such as but not limited to railroad crossings, grade changes, approaching sidings, approaching depot yards, and approaching fuel stations where each locomotive in the consist may require a different braking option. For example, if the train is coming over a hill, the lead locomotive may have to enter a braking condition whereas the remote locomotives, having not reached the peak of the hill may have to remain in a motoring state.

A technical contribution for the disclosed method and apparatus is that it provides for a computer configured to operate a hybrid vehicle and access a navigation database system and to a method of using the system.

According to one embodiment of the invention, a system for optimizing a trip for a hybrid vehicle includes a computer programmed to determine a route for the hybrid vehicle to travel, obtain altitude and terrain information of the route, and generate a trip plan based on at least the route and altitude to minimize total energy expended along the route by encouraging regenerative braking during portions of the route, regardless of needs to slow the hybrid vehicle.

In accordance with another embodiment of the invention, a method includes obtaining grade information along a route for a hybrid vehicle to travel, and generating an optimized trip plan to minimize total fuel consumption of the hybrid vehicle by promoting regenerative braking to occur during periods, for the purpose of generating energy, even when the vehicle need not be slowed.

In accordance with yet another embodiment of the invention, a vehicle includes a hybrid power source to provide power to drive the vehicle via a drivetrain, the hybrid power source comprising an internal combustion (IC) engine and an electric motor, wherein the IC engine is coupled to the drivetrain, and a bank of batteries coupled to the electric motor. The vehicle includes a switching device arranged to selectively couple the electric motor to the drivetrain. The vehicle includes a computer configured to generate a trip plan for a route from a first point to a second point, obtain grade information for the trip plan, optimize the trip plan to minimize fuel consumption, by inducing regenerative braking to occur irrespective of momentum requirements. The regenerative braking occurs by selectively coupling the drivetrain to the electric motor when the vehicle is braking.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not limited by the foregoing description, but is only limited by the scope of the appended claims.

What is claimed is:

1. A system for optimizing a trip for a hybrid vehicle, comprising a computer programmed to:
determine a route for the hybrid vehicle to travel;
obtain altitude and terrain information of the route; and
generate a trip plan based on at least the route and altitude to minimize total energy expended along the route by encouraging regenerative braking during portions of the route, regardless of needs to slow the hybrid vehicle.

2. The system of claim 1 wherein the route is determined, the altitude and terrain information are obtained, and the trip plan is generated prior to departure of the hybrid vehicle on the route.

3. The system of claim 1 wherein the computer is programmed to:
obtain at least one performance parameter of the hybrid vehicle;
generate the trip plan based on the at least one performance parameter; and
encourage braking during descents to generate power therefrom.

4. The system of claim 3 wherein the at least one performance parameter includes locomotive power data, regenerative braking characteristics, performance of locomotive traction transmission, consumption of engine fuel as a function of output power, and cooling characteristics of the hybrid vehicle.

5. The system of claim 1 wherein the computer is programmed to generate the trip plan based on at least one objective function.

6. The system of claim 5 wherein the at least one objective function includes one of a travel time, a maximum power setting, a speed limit, an exhaust emission, and a jockeying of an accelerator of the hybrid vehicle.

7. The system of claim 1 wherein the computer is further caused to revise the trip plan based on conditions that occur while the vehicle is traveling from a first point to a second point.

8. The system of claim 1 wherein the computer is configured to determine the route and obtain altitude and terrain information from a computer that is remotely located from the hybrid vehicle.

9. A method comprising:
obtaining grade information along a route for a hybrid vehicle to travel; and
generating an optimized trip plan to minimize total fuel consumption of the hybrid vehicle by promoting regenerative braking to occur during periods along the route, for the purpose of generating energy, even when the vehicle need not be slowed.

10. The method of claim 9 wherein the optimized trip plan is generated prior to departure of the hybrid vehicle.

11. The method of claim 9 wherein generating the optimized trip plan comprises using at least one powertrain performance parameter of the hybrid vehicle.

12. The method of claim 11 wherein the at least one powertrain performance parameter comprises locomotive power data, regenerative braking characteristics, performance of locomotive traction transmission, consumption of engine fuel as a function of output power, and cooling characteristics of the hybrid vehicle.

13. The method of claim 9 comprising generating a re-optimized trip plan while the hybrid vehicle is traveling along the route.

14. The method of claim 13 wherein re-optimizing the trip plan comprises using information obtained from a locator element including one of a global positioning system (GPS), a wayside device, a radio frequency automatic equipment identification (RF AEI) tag, a dispatch, and a video camera

15. The method of claim 9 comprising optimizing the trip plan to meet at least one objective parameter, wherein the objective parameter comprises one of a travel time, a maximum power setting, a speed limit, an exhaust emission, and minimizing a jockeying of an accelerator of the hybrid vehicle.

16. The method of claim 9 wherein the hybrid vehicle is a train.

17. A vehicle comprising:
a hybrid power source to provide power to drive the vehicle via a drivetrain, the hybrid power source comprising an internal combustion (IC) engine and an electric motor, wherein the IC engine is coupled to the drivetrain;
a bank of batteries coupled to the electric motor;
a switching device arranged to selectively:
couple the electric motor to the drivetrain; and
a computer configured to:
generate a trip plan for a route from a first point to a second point;
obtain grade information for the trip plan;
optimize the trip plan to minimize fuel consumption, by inducing regenerative braking to occur irrespective of momentum requirements,
wherein the regenerative braking occurs by selectively coupling the drivetrain to the electric motor when the vehicle is braking.

18. The vehicle of claim 17 wherein the computer is configured to generate the trip plan before departing from the first point.

19. The vehicle of claim 17 wherein the computer is configured to generate the trip plan based on one or more operational criteria of the vehicle.

20. The vehicle of claim 19 wherein the operational criteria include one of a total travel time, a maximum power setting, a speed limit, an exhaust emission, and minimizing a jockeying of an accelerator of the hybrid vehicle.

21. The vehicle of claim 17 wherein the computer is configured to generate the trip plan based on at least one drivetrain performance parameter of the vehicle.

22. The vehicle of claim 17 wherein the computer is configured to generate the trip plan in part with inputs from a database having past trips with similar inputs.

23. The vehicle of claim 17 wherein the computer is configured to revise the trip plan based on conditions that occur while the vehicle is traveling along the route.

24. The vehicle of claim 23 wherein the conditions comprise at least one of an unexpected delay, an unexpected stop, maintenance of the vehicle, repair of the vehicle, allowing exhaust to clear from a tunnel, a change in operational criteria, overriding needs of another train, slack time in a schedule, weather conditions, and a change in scheduling demands.

25. The vehicle of claim 23 wherein the trip plan is revised using information obtained from a locator element comprising one of a global positioning system (GPS), a wayside device, a radio frequency automatic equipment identification (RF AEI) tag, a dispatch, and a video camera.

26. The vehicle of claim 17 wherein the vehicle is a locomotive.

27. The vehicle of claim 17 wherein the IC engine is switchably coupled to the drivetrain via the switching device.
